(19) United States
(12) Patent Application Publication
(10) Pub. No.: US 2005/0007343 A1
(43) Pub. Date: Jan. 13, 2005

(54) Cell phone mouse

(76) Inventor: Dane Charles Butzer, Columbus, OH (US)

Correspondence Address: DANE C. BUTZER, 681 WOODDUCK COURT, COLUMBUS, OH, 43215, US

(21) Appl. No.: 10/614,147

(22) Filed: Jul. 7, 2003

(51) Int. Cl. G09G 5/08

(52) U.S. Cl. 345/163

(57) ABSTRACT

A cell-mouse comprising a cellular phone that doubles as a mouse for a laptop or other computer. Also, a card adapted to be inserted into a laptop or other computer that enables the computer to communicate with a cell-mouse through the cell-mouse's cellular communication hardware, and a laptop or other computer adapted to communicate with a cell-mouse through the cell-mouse's cellular communication hardware.

### BACKGROUND OF THE INVENTION

1. Field of the Invention

This invention relates to a cellular phone that also works as a mouse for a laptop or other computer system.

2. Description of the Related Art

Two items have become ubiquitous for business people on the go: laptop computers and cellular phones. One item is invariably left behind: a mouse.

Laptop computers provide functional alternatives to mice, including touch pads and track sticks. However, neither a touch pad nor a track stick provides the same level of control and comfort as the traditional mouse. Despite this, business people rarely bring a mouse with them—they simply suffer through use of the touch pad or track stick.

### SUMMARY OF THE INVENTION

Accordingly, one aspect of the invention is a cellular (i.e., cell) phone that doubles as a mouse for a laptop or other computer. This device is referred to as a “cell-mouse” herein.

The cell-mouse can operate as a wireless mouse, communicating with the computer using an infrared link or using the cell-mouse's cellular communication hardware. Alternatively, the cell-mouse can be adapted to connect to the laptop or other computer using a wire or cable.

The cell-mouse can use rollers, optical sensors, accelerometers, or any other mechanism to detect motion of the cell-mouse. Preferably, the cell-mouse includes mouse buttons and/or a scroll wheel.

Another aspect of the invention is an add-on that enables the cellular phone to operate as a cell-mouse.

Yet another aspect of the invention is a card (e.g., PCM or PCMCIA card) adapted to be inserted into a laptop or other computer that enables the computer to communicate with a cell-mouse through the cell-mouse's cellular communication hardware. A further aspect of the invention is a laptop or other computer adapted to communicate with a cell-mouse through the cell-mouse's cellular communication hardware.

Other aspects of the invention encompass methods of making and using the foregoing devices.

This brief summary has been provided so that the nature of the invention may be understood quickly. A more complete understanding of the invention may be obtained by reference to the following description of the preferred embodiments thereof in connection with the attached drawings.

### BRIEF DESCRIPTION OF THE DRAWINGS

FIG. 1 shows a cell-mouse in wireless communication with a laptop computer according to an aspect of the invention.

FIG. 2 show a cell-mouse in wireless communication with a laptop computer according to another aspect of the invention.

FIG. 3 shows a cell-mouse communicating with a desktop computer system through a wire or cable according to another aspect of the invention.

FIG. 4 shows a block diagram of a cell-mouse according an aspect of the invention.

FIG. 5 shows an add-on that can be used to convert a normal cellular phone into a cell-mouse according to the invention.

### DESCRIPTION OF THE PREFERRED EMBODIMENT

A “cell-mouse” (also called a “cellular phone mouse” or “cellular mouse” herein) is a cellular phone that doubles as a mouse for a laptop or other computer. Business travelers invariably have their cell phones and laptops with them. If a person's cell phone is enabled to be a cell-mouse according to the invention, he or she will be able to use the cell-mouse instead of a touch pad, track stick, or other cumbersome integrated pointing device, all without the hassle of lugging along yet another device (e.g., a separate dedicated mouse). Of course, the person will still be able to use another pointing device if he or she so desires.

The term “cellular phone” or “cell phone” broadly includes all types of portable phones, including but not limited to traditional cell phone, PCS (personal communication system) phones, G3 phones, direct-connect devices, etc.

The term “mouse” refers to any hand-held pointing device for a computer system. Mice include, but are not limited to, more traditional-style roller based mice, optical mice, accelerometer based mice, hand-held free-space pointing devices, and other types of pointing devices.

The term “laptop computer” refers to any type of portable computing device. Thus, the invention is applicable to notebook-sized laptop computers, smaller or larger portable computers, pocket PCs, handheld PCs, palmtops, PIMS (personal information managers), PDAs (personal data assistants), and other types of portable computing devices.

The term “other computer” refers to any type of computing device. Thus, the invention also is applicable to desktop computers, towers, servers, and any other types of computing devices.

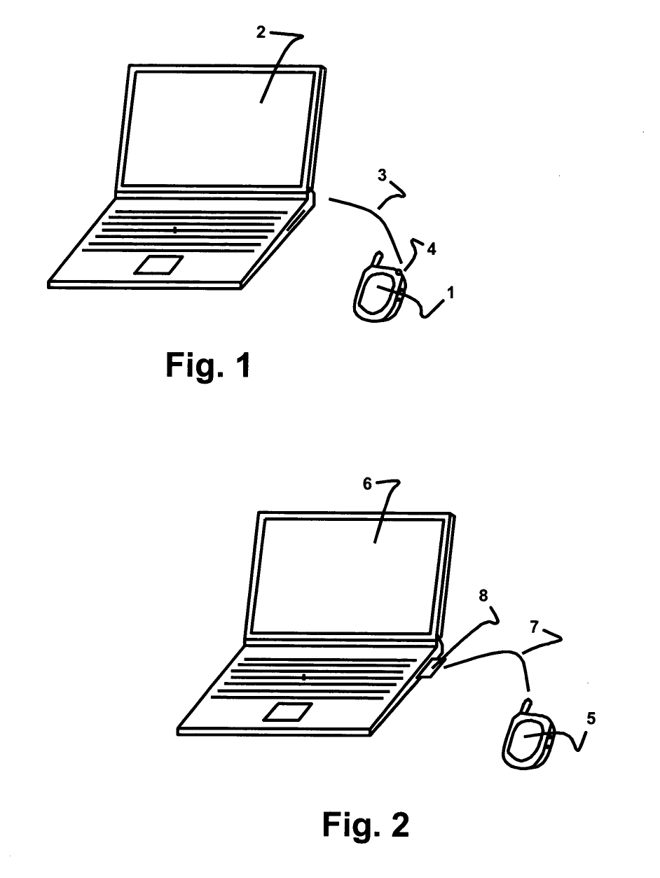

FIG. 1 shows a cell-mouse in wireless communication with a laptop computer according to an aspect of the invention. Cell-mouse 1 is a cellular phone that doubles as a wireless mouse for laptop computer 2.

In FIG. 1, cell-mouse 1 uses infrared link 3 to communicate with laptop computer 2. Thus, cell-mouse 1 includes infrared transceiver 4 and attendant hardware and software (not shown) for establishing and using infrared link 3.

In FIG. 1, laptop computer 2 is adapted to communicate with cell-mouse 1 over infrared link 3 without the need for any additional hardware such as a communication card.

In an alternative embodiment, a communication card and attendant software adapts laptop computer 2 to communicate with cell-mouse 1 over infrared link 3. The communication card can be a PCM or PCMCIA card. Other types of communication cards can be used.

FIG. 2 show a cell-mouse in wireless communication with a laptop computer according to another aspect of the invention. Cell-mouse 5 is a cellular phone that doubles as a wireless mouse for laptop computer 6. Cell-mouse 5 communicates with laptop computer 6 using wireless link 7.

The cellular phone aspects of cell-mouse 5 include hardware and/or software used for cellular or other communication. Cell-mouse 5 can use at least part of this hardware and/or software to communicate with laptop computer 6 when operating as a mouse. Cell-mouse 5 can utilize channel sharing and negotiation capabilities of the cell phone hardware and/or software to help alleviate interference with other cell-mice and computers. Cell-mouse 5 can further alleviate interference by transmitting at a lower power when functioning as a mouse compared to when operating as a cellular phone.

Alternatively, the mouse hardware and/or software can be completely separate from the cell phone hardware and/or software in cell-mouse 5. Even if the hardware and software for mouse communication is separate, techniques along the lines of those discussed above can still be used to help alleviate interference with other cell-mice and computers.

Communication card 8 and attendant software adapt laptop computer 6 to communicate with cell-mouse 5 over wireless link 7. Communication card 8 can be a PCM or PCMCIA card. Other types of communication cards can be used.

In an alternative embodiment, laptop computer 6 is adapted to communicate with cell-mouse 5 over wireless link 7 without the need for any additional hardware such as communication card 8.

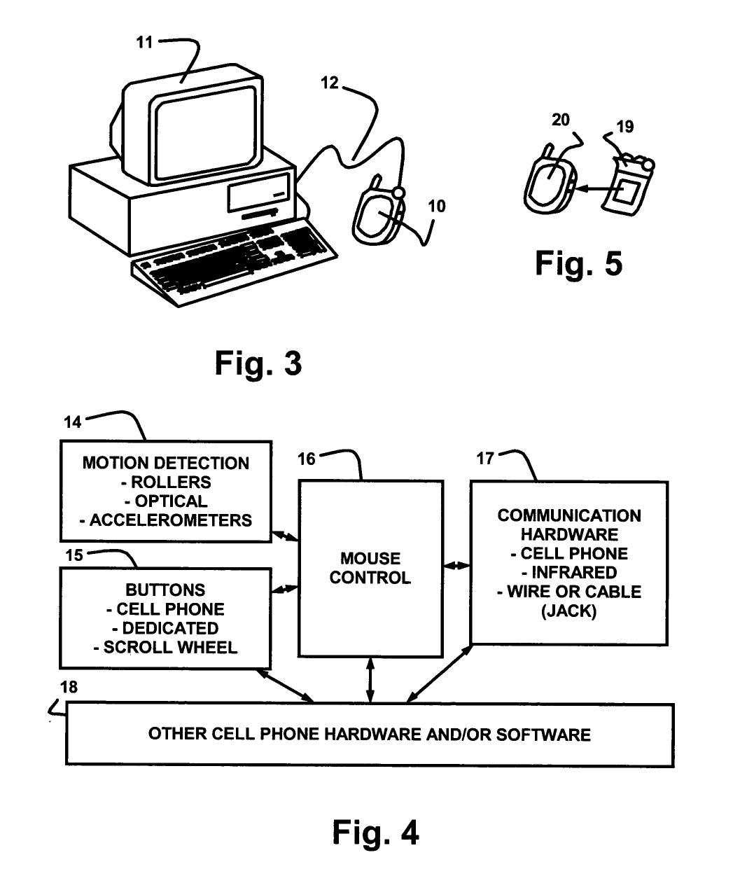

FIG. 3 shows a cell-mouse communicating with a desktop computer system through a wire or cable according to another aspect of the invention. Cell-mouse 10 is a cellular phone that doubles as a mouse for desktop computer 11. Cell-mouse 10 connects to desktop computer 11 through wire or cable 12. Cell-mouse 10 includes a jack (not shown) for connection of this wire or cable.

FIG. 3 illustrates that cell-mice according to the invention are not limited to use with portable computing devices such as laptop computers. Cell-mice according to the invention can be used with any type of computing devices.

FIG. 3 also illustrates that cell-mice according to the invention do not have to operate as wireless mice. The wire-connected type of cell-mouse still provides an advantage over a traditional mouse: instead of having to carry along a separate mouse, a person would only have to carry a wire or cable for connecting the cell-mouse to a computer.

FIG. 4 shows a block diagram of a cell-mouse according an aspect of the invention.

One embodiment of a cell-mouse includes cellular phone hardware and mouse hardware embodied in a single unit. Thus, FIG. 4 shows mouse hardware including motion detection elements 14, buttons or the like 15, mouse control 16, and communication hardware 17. Some or all of the mouse hardware can be separate or shared with the cellular phone hardware, as can any associated software. Thus, communication hardware 17 includes “cell phone” as one possible embodiment. FIG. 4 also shows other cell phone hardware and/or software 18.

Motion detection elements 14 can be embodied using any of numerous different technologies. These include, but are not limited to, traditional rollers, optical sensors, accelerometers, other inertia or motion-based sensors, and any other types of motion detection elements.

If accelerometers are used, one possible embodiment is as accelerometers micromachined on an internal computer chip. This embodiment has the advantage that the motion detection elements are unobtrusive—the cell-mouse can look like any other cellular phone.

Different embodiments of the cell-mouse can detect motion in one, two or three dimensions (four if time is counted as a dimension). Different embodiments also can detect motion about different axes.

Buttons 15 can be separate dedicate mouse buttons included in the cell-mouse. Alternatively, buttons that are present to perform cell phone functions can serve double-duty as mouse buttons. Other type of buttons, for example a scroll wheel or the like, also can be included.

Mouse control 16 is hardware and/or software that provide control functions for the mouse aspects of the cell-mouse. In some embodiments, mouse control is separate from control for the cellular phone aspects of the cell-mouse. In other embodiments, some or all of the control hardware and/or software for the cellular phone aspects of the cell-mouse serve double duty to control the mouse aspects.

Communication hardware 17 provides communication between the cell-mouse and a laptop or other computer system. The communication hardware can include hardware for an infrared or other wireless link, a jack for a wired link, or the like. In some embodiments, the communication hardware for the mouse aspects of the cell-mouse is separate from the communication hardware for the cell phone aspects. In other embodiments, some or all of the communication hardware serves double duty for the mouse and the cell phone aspects.

The cell-mouse in FIG. 4 also includes any additional hardware and/or software 18 necessary for operation of the cell-mouse as a cellular phone.

FIG. 5 shows another aspect of the invention, namely add-on 19 that can be used to convert cellular phone 20 into a cell-mouse according to the invention. One embodiment of this add-on would include motion detection elements, buttons and the like, mouse control, and communication hardware.

Alternative Embodiments

Any of the features described above and depicted in the figures can be used with any of the other features. Thus, for example, a cell-mouse can communicate with a laptop computer (FIGS. 1 and 2) through a wire or cable (FIG. 3), and a cell-mouse can communicate wirelessly (FIGS. 1 and 2) with a desktop or other computer (FIG. 3). Likewise, the various elements shown in FIG. 4 can be used in various combinations with the elements shown in the other figures. Other combinations of the features shown in the figures are possible. Furthermore, although preferred embodiments of the invention are disclosed herein, many variations are possible which remain within the content, scope and spirit of the invention, and these variations would become clear to those skilled in the art after perusal of this application.

1. A cell-mouse comprising a cellular phone that doubles as a mouse for a laptop or other computer.

2. A cell-mouse as in claim 1, wherein the cell-mouse operates as a wireless mouse.

3. A cell-mouse as in claim 2, wherein the cell-mouse communicates with the laptop or other computer using an infrared link.

4. A cell-mouse as in claim 2, wherein the cell-mouse communicates with the laptop or other computer using the cell-mouse's cellular communication hardware.

5. A cell-mouse as in claim 1, wherein the cell-mouse is adapted to connect to the laptop or other computer through a wire or cable.

6. A cell-mouse as in claim 1, wherein the cell-mouse includes rollers that detect motion of the cell-mouse.

7. A cell-mouse as in claim 1, wherein the cell-mouse includes optical sensors that detect motion of the cell-mouse.

8. A cell-mouse as in claim 1, wherein the cell-mouse includes accelerometers that detect motion of the cell-mouse.

9. A cell-mouse as in claim 1, wherein the cell-mouse includes mouse buttons.

10. A cell-mouse as in claim 1, wherein the cell-mouse include a scroll wheel.

11. A cell-mouse, comprising cellular phone hardware and mouse hardware embodied in a single unit.

12. A cell-mouse as in claim 11, wherein the mouse hardware includes one or more motion detection elements, one or more control elements, one or more mouse buttons, and communication hardware.

13. A cell-mouse as in claim 11, wherein some or all of the cellular phone hardware and mouse hardware is shared.

14. An add-on for a cellular phone, comprising a unit that enables the cellular phone to operate as a cell-mouse.

15. An add-on as in claim 14, wherein the unit includes one or more motion detection elements, one or more control elements, one or more buttons, and communication hardware.

16. A card adapted to be inserted into a laptop or other computer that enables the computer to communicate with a cell-mouse through the cell-mouse's cellular communication hardware.

17. A laptop or other computer adapted to communicate with a cell-mouse through the cell-mouse's cellular communication hardware.
